(19) United States
(12) Patent Application Publication
(10) Pub. No.: US 2025/0199312 A1
(43) Pub. Date: Jun. 19, 2025

(54) EXTENDED REALITY PROJECTION USING POLYCHROME PIXEL PANELS WITH COORDINATED PIXEL ARRANGEMENTS

(71) Applicant: Google LLC, Mountain View, CA (US)

(72) Inventors: Daniel Adema, Kitchener (CA); Shreyas Potnis, Kitchener (CA)

(21) Appl. No.: 18/538,817

(22) Filed: Dec. 13, 2023

(51) Int. Cl. G02B 27/01; G02C 5/02

(52) U.S. Cl. CPC G02B 27/0172; G02C 5/02; G02B 2027/0132; G02B 2027/0178

(57) ABSTRACT

Illustrative systems and methods for performing extended reality projection using polychrome pixel panels with coordinated pixel arrangements are described herein. For example, an extended reality projection system may include a head-mounted display and a set of polychrome pixel panels collectively configured to produce a color image for presentation on the head-mounted display. The set of polychrome pixel panels may be configured with a coordinated pixel arrangement in which, for a particular pixel position: 1) a first panel of the set of polychrome pixel panels includes a red pixel, 2) a second panel of the set of polychrome pixel panels includes a green pixel, and 3) a third panel of the set of polychrome pixel panels includes a blue pixel. Corresponding methods and systems are also disclosed.

### TECHNICAL FIELD

This description relates to image content projection by an extended reality projection system with a binocular head-mounted display.

### BACKGROUND

Extended reality is an umbrella term referring to various technologies that serve to augment, virtualize, or otherwise extend a user's experience of reality in a variety of ways. For example, augmented reality, virtual reality, mixed reality, and other similar technologies refer to different types of extended reality that have been developed and deployed for use with entertainment, educational, vocational, and other types of applications. In certain cases, extended reality experiences may be presented on head-mounted displays to increase the immersiveness of the experience by filling the user's visual field and freeing up the user's hands for other tasks such as holding and manipulating an extended reality controller.

### SUMMARY

Systems and methods for extended reality projection using polychrome pixel panels with coordinated pixel arrangements are described herein. For various reasons described herein, it may be desirable for an extended reality projection system to be characterized by a small pixel pitch parameter, or, in other words, for the pixels of a display panel integrated into the extended reality projection system to be packed as closely to one another as possible. To this end, systems and methods described herein include separate, polychrome pixel panels that are coordinated such that different colors on each polychrome pixel panel are superimposed onto one another and pixels of the same color thereby have a significantly decreased pitch as compared to the pitch of like-colored pixels within a conventional polychrome pixel panel. For example, rather than a polychrome pixel panel that intermingles red, green, and blue pixels (positioning the pixels such that like-colored pixels are never adjacent to one another), methods and systems described herein utilize separate but coordinated polychrome pixel panels that each include one pixel of each primary color (e.g., red, green, and blue pixels according to one color scheme) in every pixel position so as to overlay the three colors at each position and minimize the pitch between pixels of the same color.

A waveguide that guides light from separate pixel panels to a lens in front of a viewer's eye may include three separate apertures to input the light from the separate pixel panels. For any given pixel position, challenges with balancing different channels carrying light of different colors from the different input apertures may cause light delivered by such a multi-aperture waveguide to tend to exhibit at least some color non-uniformity (e.g., images that appear to skew more toward one of the pixel panels more than another for a particular region). Along with other potential correction techniques, methods and systems described herein help increase perceived color uniformity in extended reality projection systems by coordinating the arrangements of polychrome pixel panels in ways described herein. In this way, any color non-uniformity presented at one pixel position may be offset, at least as the user perceives it, by opposite, complementary, or at least different color non-uniformities presented at neighboring pixel positions in the coordinated arrangement. For example, if a multi-aperture waveguide causes one pixel at a first pixel position to skew red, the coordinated arrangements described herein may result in other pixels at neighboring positions to skew away from the red (e.g., toward green or blue). When this effect is compounded over all the pixels in the image, the user's brain may perceive little or no color non-uniformity in its final analysis, as any non-uniformity that exists at any given pixel position will be balanced and effectively cancelled by its neighbors.

In one implementation, an extended reality projection system includes: 1) a head-mounted display; and 2) a set of polychrome pixel panels collectively configured to produce a color image for presentation on the head-mounted display. The set of polychrome pixel panels may be configured with a coordinated pixel arrangement in which, for a particular pixel position: a first panel of the set of polychrome pixel panels includes a red pixel, a second panel of the set of polychrome pixel panels includes a green pixel, and a third panel of the set of polychrome pixel panels includes a blue pixel. In other words, for any particular pixel position (e.g., a pixel position on a top row of the display screen and at the left-most column, etc.), the separate pixel panels in the set of polychrome pixel panels may be coordinated such that a first panel has a red pixel at that position, a second panel has a green pixel at that position, and a third panel has a blue pixel at that position. Then, for a neighboring pixel position (e.g., a pixel position on the top row of the display screen and at the second to left-most column, etc.), the separate pixel panels in the set of polychrome pixel panels may be in a different configuration that is configured to help balance any color non-uniformity that may be caused by a multi-aperture waveguide guiding light to this region of the display screen. For instance, at this neighboring pixel position, the coordinate arrangement may be such that the first panel has a green pixel at that position, the second panel has a blue pixel at that position, and the third panel has a red pixel at that position. In this way, a user of the head-mounted display may perceive color that accurately reflects the desired color, even while the pixel pitch exhibits the benefits arising from multiple pixel panels feeding into a multi-aperture waveguide.

In another implementation, a method comprises steps including: 1) producing, by a red pixel at a particular pixel position in a first panel of a set of polychrome pixel panels within a head-mounted display, red light for a color image presented on the head-mounted display; 2) producing, by a green pixel at the particular pixel position in a second panel of the set of polychrome pixel panels, green light for the color image; and 3) producing, by a blue pixel at the particular pixel position in a third panel of the set of polychrome pixel panels, blue light for the color image.

In yet another implementation, an augmented reality glasses device includes: 1) a left lens associated with a left side of the augmented reality glasses device and configured to facilitate a display of a color image while allowing a passage of light from an environment; 2) a right lens associated with a right side of the augmented reality glasses device and configured to facilitate the display of the color image while allowing the passage of light from the environment; 3) a frame configured to hold the left lens and the right lens and including a left endpiece on the left side, a right endpiece on the right side, and a bridge between the left endpiece and the right endpiece; 4) a first set of polychrome pixel panels collectively configured to produce the color image for presentation on the left side, the first set of polychrome pixel panels configured with a coordinated pixel arrangement; 5) a first waveguide configured to guide light from the first set of polychrome pixel panels to achieve the presentation on the left side, the first waveguide integrated into the left lens and including separate input apertures for each polychrome pixel panel in the first set of polychrome pixel panels; 6) a second set of polychrome pixel panels collectively configured to produce the color image for presentation on the right side, the second set of polychrome pixel panels configured with the coordinated pixel arrangement; and 7) a second waveguide configured to guide light from the second set of polychrome pixel panels to achieve the presentation on the right side, the second waveguide integrated into the right lens and including separate input apertures for each polychrome pixel panel in the second set of polychrome pixel panels.

The details of these and other implementations are set forth in the accompanying drawings and the description below. Other features will also be made apparent from the following description, drawings, and claims.

### BRIEF DESCRIPTION OF THE DRAWINGS

FIG. 1 shows an illustrative extended reality projection system configured with polychrome pixel panels with coordinated pixel arrangements in accordance with principles described herein.

FIG. 2 shows an illustrative method for extended reality projection using polychrome pixel panels with coordinated pixel arrangements in accordance with principles described herein.

FIG. 3 shows pixel pitch characteristics for illustrative polychrome pixel panels in accordance with principles described herein.

FIG. 4 shows illustrative optical angles presented by corresponding pixels in like pixel positions within coordinated pixel arrangements in accordance with principles described herein.

FIGS. 5A and 5B show illustrative binocular head-mounted displays using polychrome pixel panels in example coordinated pixel arrangements in accordance with principles described herein.

FIGS. 6A and 6B show additional illustrative binocular head-mounted displays using polychrome pixel panels in additional example coordinated pixel arrangements in accordance with principles described herein.

FIG. 7 shows illustrative aspects of multi-aperture waveguides used by illustrative head-mounted displays in accordance with principles described herein.

### DETAILED DESCRIPTION

Systems and methods for extended reality projection using polychrome pixel panels with coordinated pixel arrangements are described herein. For an extended reality projection system to provide a high-resolution image with a wide field of view while still fitting in the relatively compact form factor of a head-mounted display (e.g., a pair of augmented reality glasses, a mixed reality headset, etc.), it may be desirable for a focal length of the projection system to be as short as possible. More particularly, it may be desirable for a given extended reality projection system design to have a relatively short optical track (which is associated with the focal length) to fit in the relatively compact form factor of a head-mounted display without compromising on the pixel resolution and field of view that may be desired to provide a highly immersive and enjoyable extended reality experience for the user.

As will be described in more detail below, the focal length of a projection system is directly related to the pixel resolution, the field of view being projected, and the pitch of the pixels on a panel (i.e., how close together the pixels are). Accordingly, for user-perceivable performance characteristics (e.g., pixel resolution, field of view, etc.) to be optimized in a particular system, a technical problem arises related to minimizing the pitch of the pixels in the system. In particular, for a color projection system in which each full-color pixel is actually made up of at least one red, one green, and one blue pixel (collectively referred to as a red-green-blue (RGB) pixel), a technical challenge is presented to minimize the effective pitch between RGB pixels. As will be illustrated below, the effective pitch of RGB pixels may refer to a distance between any two pixels of the same color within a pixel panel (e.g., the distance from red pixel to red pixel, or from green pixel to green pixel, etc.).

As mentioned above, one technical solution to this problem of reducing effective pixel pitch is to replace single-aperture waveguides and single polychrome pixel panels (panels featuring interleaved patterns of red, green, and blue pixels in which no like-colored pixels are adjacent to one another) with multi-aperture waveguides and a set of separate polychrome pixel panels that are configured with coordinated pixel arrangements (such that red, green, and blue pixels are superimposed at each pixel position). As will be illustrated in more detail below, this pitch reduction results from the fact that each color of pixel (i.e., red, green, and blue in an RGB color scheme) is present at every pixel position such that the effective pixel pitch of RGB pixels is only the distance from one pixel to the immediately-adjacent neighboring pixel (rather than to a neighbor that is at least one pixel away, as would be the case for a single polychrome pixel panel in which no superimposed pixels are presented at corresponding positions).

As the pixel pitch problem is addressed in this way by the deployment of separate pixel panels, associated multi-aperture waveguides, and the superimposing of pixels to create effective RGB pixels at each pixel position, however, an additional technical problem arises. Specifically, it may be extremely difficult for any real-world multi-aperture waveguide to perfectly balance the way light is carried from all three pixel panels to the eye of the user. For example, a particular waveguide may overemphasize a first pixel panel coming into a first input aperture while underemphasizing a second pixel panel coming into a second input aperture. This issue may vary across the display screen from region to region (from pixel position to pixel position) such that, if not strategically arranged, a user could perceive certain RGB pixels (at certain pixel positions) as being overly skewed toward one pixel panel or another. This type of color skew is referred to herein as an inaccurate or non-uniform color presentation and will be understood to be an undesirable side effect of reducing pixel pitch by way of using separate pixel panels rather than a single polychrome pixel panel.

To address this color non-uniformity problem, systems and methods described herein present a technical solution that uses polychrome pixel panels with coordinated pixel arrangements. For example, as used herein, pixel arrangements between different polychrome pixel panels may be coordinated in at least two ways. First, as described above, the pixel arrangements may be coordinated such that each pixel position is configured with a superimposing of a pixel of each color (i.e., a red pixel, a green pixel, and a blue pixel), such that a full-color, RGB pixel is presented at each pixel position of the display screen.

Second, these pixel arrangements may be coordinated such that the superimposing of the red, green, and blue pixels at each pixel position is different from its immediate neighbors. For example, if a given pixel position implements an RGB pixel by having a red pixel from a first polychrome pixel panel superimposed with a green pixel from a second polychrome pixel panel and a blue pixel from a third polychrome pixel panel, one or more neighboring pixel positions (e.g., immediately to the right and immediately below the pixel position) may implement an RGB pixel by having a green pixel from the first polychrome pixel panel superimposed with a blue pixel from the second polychrome pixel panel and a red pixel from the third polychrome pixel panel. Other neighboring pixel positions in this example (e.g., immediately to the left and immediately above the pixel position) could then implement an RGB pixel by having a blue pixel from the first polychrome pixel panel superimposed with a red pixel from the second polychrome pixel panel and a green pixel from the third polychrome pixel panel. In this way, any color-nonuniformity that might be created by the multi-aperture waveguide emphasizing light from one pixel panel over another (e.g., due to the design challenges described above) would be effectively balanced or cancelled out (at least as perceived by the user as he or she views a large number of pixels at once). In other words, even if, for a particular region, one pixel panel tends to be overemphasized and/or another pixel panel tends to be underemphasized, the coordinated pixel arrangement may ensure that this will not exhibit itself as perceivable color non-uniformity since all three colors would be equally overemphasized and underemphasized within that region.

Accordingly, technical benefits of this solution may include at least that: 1) the effective pixel pitch may be decreased as compared to conventional polychrome pixel panels and waveguides so as to support significant improvements in system characteristics such as head-mounted display size and weight, screen resolution, screen field of view, and so forth; and 2) an effective color balance of the extended reality projection system is improved (i.e., such that a user of the head-mounted display perceives color that is less skewed in any direction and more accurately reflects the desired color).

Various implementations will now be described in more detail with reference to the figures. It will be understood that the particular implementations described below are provided as non-limiting examples and may be applied in various situations. Additionally, it will be understood that other implementations not explicitly described herein may also fall within the scope of the claims set forth below. Systems and methods described herein for extended reality projection using polychrome pixel panels with coordinated pixel arrangements may result in any or all of the technical benefits mentioned above, as well as various additional technical benefits that will be described and/or made apparent below.

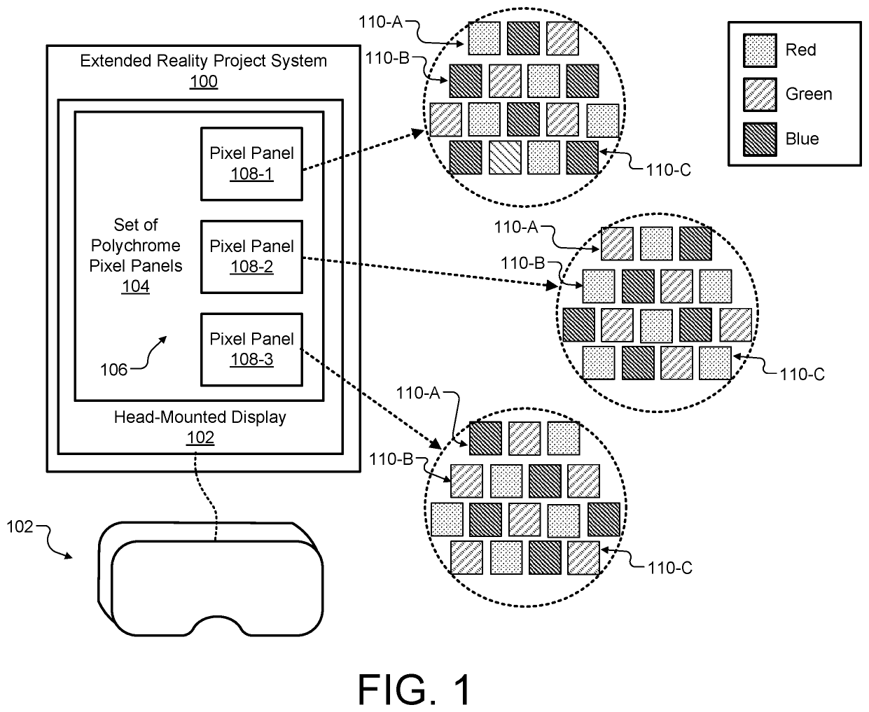

FIG. 1 shows an illustrative extended reality projection system 100 configured with polychrome pixel panels with coordinated pixel arrangements in accordance with principles described herein. As shown, system 100 includes a head-mounted display 102 that is illustrated both as a block in the block diagram of system 100 and as a physical device representing any binocular head-mounted display such as a virtual reality headset, a mixed reality headset, an augmented reality glasses device, or the like.

As shown in FIG. 1, head-mounted display 102 may include a set 104 of polychrome pixel panels distributed in an arrangement 106. This set 104 of polychrome pixel panels may be collectively configured to produce a color image for presentation on head-mounted display 102. To this end, set 104 is shown to include three separate polychrome pixel panels including a pixel panel 108-1, a pixel panel 108-2, and a pixel panel 108-3 (collectively referred to as pixel panels 108).

While each of the pixel panels 108 within set 104 includes an array of pixels including all of the primary colors (i.e., red, green, and blue colors in this RGB color scheme), FIG. 1 shows that the arrangement 106 of pixels in these different pixel panels 108 may be a coordinated pixel arrangement that allows for a smaller pixel pitch, a reduced perception of color non-uniformity, and other advantages described herein. Specifically, as shown in FIG. 1, a small sampling of a few example pixels at corresponding pixel positions are drawn in circles associated with each of polychrome pixel panels 108-1, 108-2, and 108-3. In FIG. 1 and other figures below, individual pixels are depicted as squares with different types of fill styles representing their color. For example, as indicated by the key in the corner of the figure, a dotted fill style indicates a box representing a red pixel, a wide cross-hatching style (diagonal-down-to-the-left) indicates a box representing a green pixel, and a narrow cross-hatching style (diagonal-down-to-the-right) indicates a box representing a blue pixel.

While only a small sampling of pixels is shown for each pixel panel 108 (in the respective circles associated with the pixel panels), it will be understood that these samplings represent corresponding pixels at the same pixel positions for each pixel panel. To give a few examples, a left-most pixel on the top row of each sampling is labeled to be at a pixel position 110-A of each pixel panel 108, a left-most pixel on the second-to-top row of each sampling is labeled to be at a pixel position 110-B of each pixel panel 108, and a right-most pixel on the bottom row of each sampling is labeled to be at a pixel position 110-C of each pixel panel 108. Pixels at the same pixel position will be understood to be superimposed over one another when guided through a multi-aperture waveguide to be presented to a user of head-mounted display 102. For example, a multi-aperture waveguide within head-mounted display 102 (not shown in FIG. 1, but illustrated and described in more detail below) may be configured to guide light from each of the three pixels at pixel position 110-A (i.e., the red pixel of pixel panel 108-1, the green pixel of pixel panel 108-2, and the blue pixel of pixel panel 108-3) to be presented to the user's eye at a same particular angle. As such, these three pixels at pixel position 110-A may be superimposed so as to collectively form a single RGB pixel on a display screen presented by head-mounted display 102 to the user. Similarly, the multi-aperture waveguide may be configured to guide light from each of the three pixels at pixel position 110-B (i.e., the blue pixel of pixel panel 108-1, the red pixel of pixel panel 108-2, and the green pixel of pixel panel 108-3) to be presented to the user's eye at another particular angle. Here again, these three pixels at pixel position 110-B may therefore be superimposed so as to collectively form another RGB pixel on the display screen presented to the user. Likewise, the multi-aperture waveguide may be configured to guide light from each of the three pixels at pixel position 110-C (i.e., the blue pixel of pixel panel 108-1, the red pixel of pixel panel 108-2, and the green pixel of pixel panel 108-3) to be presented to the user's eye at yet another particular angle. As with the other examples, these three pixels at pixel position 110-C may again be superimposed so as to collectively form a yet another RGB pixel on the display screen presented by head-mounted display 102.

As has been described, even if there is some amount of color non-uniformity that arises from technical challenges associated with the design of the multi-aperture waveguide, arrangement 106 is configured to help balance, cancel out, and/or otherwise mitigate such color non-uniformity, at least as perceived by the user. For example, rather than using monochrome pixel panels for set 104 (e.g., an all-red monochrome pixel panel in place of pixel panel 108-1, an all-green monochrome pixel panel in place of pixel panel 108-2, and an all-blue monochrome pixel panel in place of pixel panel 108-3), set 104 instead includes polychrome pixel panels that interleave the primary colors in the arrangement 106 that is shown. In this way, even if a multi-aperture waveguide were to, for example, cause the region around pixel positions 110-A through 110-C to skew toward light produced by pixel panel 108-1, that skew would not be perceived as color non-uniformity since all three primary colors would be both overemphasized and underemphasized (at the various pixel positions within the region) to approximately the same degree. For example, at pixel position 110-A, the pixel might appear to be slightly too red (since pixel panel 108-1 supplies the red pixel at this pixel position), but this would be balanced by the fact that, at neighboring pixel positions such as pixel position 110-B, pixels would appear to be not quite red enough (i.e., since pixel panel 108-1 supplies the blue pixel at this pixel position and the red pixel is supplied by underemphasized pixel panel 108-2).

The polychrome pixel panels 108 may be implemented in any manner as may serve a particular implementation. For instance, in some implementations the different polychrome pixel panels 108 may be manufactured on their own semiconductor substrates (as separate chips on separate dies). In other implementations, the three polychrome pixel panels 108 in set 104 could all be manufactured on different portions of a same die (i.e., the three panels sharing a same physical substrate but being situated in separate sections instead of being intermixed). For both of these types of implementations, it will be understood that a waveguide associated with the set 104 of polychrome pixel panels 108 may be a multi-aperture waveguide with separate, dedicated in-couplers for each pixel panel.

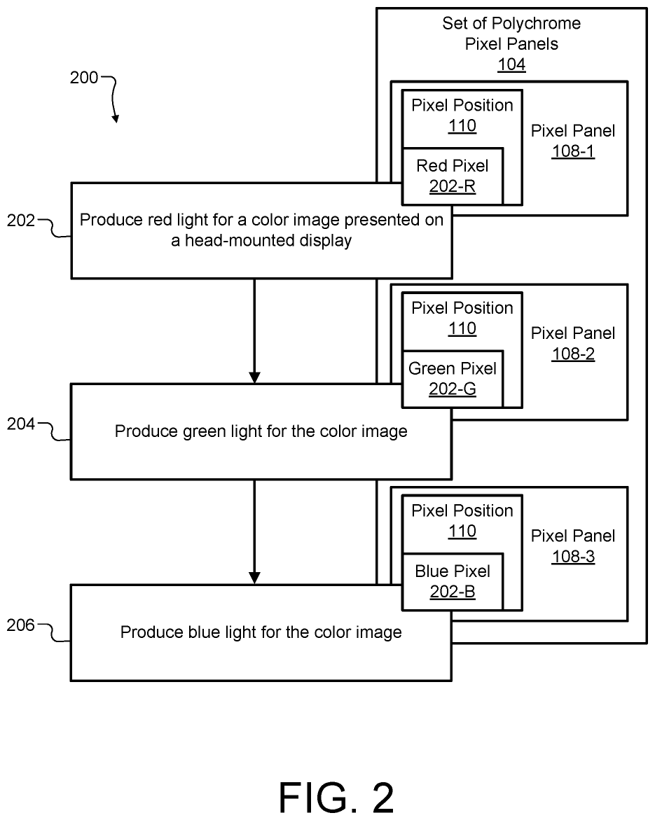

FIG. 2 shows an illustrative method 200 for extended reality projection using polychrome pixel panels with coordinated pixel arrangements in accordance with principles described herein. While FIG. 2 shows illustrative operations 202-206 according to one implementation, other implementations of method 200 may omit, add to, reorder, and/or modify any of the operations shown in FIG. 2. In some examples, multiple operations shown in FIG. 2 or described in relation to FIG. 2 may be performed concurrently (e.g., in parallel) with one another, rather than being performed sequentially as illustrated and/or described.

Each of operations 202-206 of method 200 will now be described in more detail as the operations may be performed by an implementation of system 100. For example, as illustrated to the side of operations 202-206 in FIG. 2, method 200 may be performed by individual pixels within the set 104 of polychrome pixel panels 108 as these pixels are arranged in a coordinated pixel arrangement (e.g., arrangement 106 illustrated and described above in relation to FIG. 1). More particularly, as shown, a red pixel 202-R, a green pixel 202-G, and a blue pixel 202-B in a coordinated pixel arrangement may perform the respective operations of method 200 to produce an effective RGB pixel associated with a pixel position 110 (e.g., any of pixel positions 110-A, 110-B, 110-C, or another suitable position). Light produced by each of pixels 202-R, 202-G, and 202-B may be superimposed by a multi-aperture waveguide (not explicitly shown) such that the light from all three colors is presented as originating from a same angle to form an effective RGB pixel associated with the pixel position 110 on a virtual display screen presented to the user.

At operation 202, system 100 may produce red light for a color image presented on a head-mounted display such as head-mounted display 102. As shown, for instance, operation 202 may be performed by red pixel 202-R, which may be located at the particular pixel position 110 in pixel panel 108-1 of the set 104 of polychrome pixel panels.

At operation 204, system 100 may produce green light for the color image presented on the head-mounted display. For example, as shown, operation 204 may be performed by green pixel 202-G, which may be located at the same particular pixel position 110 as red pixel 202-R, but is included within a different pixel panel 108-2 of the set 104 of polychrome pixel panels.

At operation 206, system 100 may produce blue light for the color image presented on the head-mounted display. For example, as shown, operation 206 may be performed by blue pixel 202-B, which, again, may be located at the same particular pixel position 110 as red pixel 202-R and green pixel 202-G, but which is integrated with yet another pixel panel 108-3 of the set 104 of polychrome pixel panels.

The optical pathway between a set of pixel panels (e.g., set 104 of pixel panels 108) and the eyes of a user for a given extended reality projection system generally include several components. First, projector optics (also referred to as a projector optical system) may include a series of lenses and/or other optical devices immediately adjacent to the pixel panels to process and prepare light generated by the pixel panels. For example, while each pixel may produce light that radiates in a wide angle (e.g., acting as or approximating a Lambertian emitter), an optical track of projector optics may be configured collimate the light to a certain diameter (e.g., to make the light from each pixel travel in parallel angles). After propagating through this projector optical system, the now-collimated light may enter a waveguide integrated or otherwise associated with a lens positioned in front of one of the user's eyes. The waveguide may be configured to direct or guide the light to enter the user's eye at an angle that simulates light the user would see if viewing a real object some distance away. As such, the user need not focus on an actual image presented immediately before their eyes on the lens, but, rather, may focus their eyes as if looking at a display screen (also referred to herein as a virtual display screen) that is some distance away (e.g., several meters from the user). In other words, the waveguide may be configured to direct the light to enter the user's eyes at the proper angles to simulate light originating at a virtual display screen much farther from the eyes than the distance of the actual optics themselves (i.e., the lenses, waveguides, etc., of the head-mounted display).

As mentioned above, various design parameters desirable for an extended reality projection system may include a high pixel resolution (e.g., to show intricate details of projected content), a wide field of view (e.g., to flexibly project content to a wide range within the user's visual field), and a short optical track length (e.g., to fit in the form factor of a streamlined head-mounted display device). Optical physics may dictate the relationship between these features as per Equation 1:

$$Focal\_Length = \frac{Resolution * FOV * Pitch}{2 * tan ( \frac{FOV}{2} )} \qquad ( Eq l )$$

In Equation 1, Focal_Length may be equal or related to the optical track length through the projector optical system described above. As mentioned, it may be desirable for this to be short enough (e.g., a few millimeters) to fit within a head-mounted display (e.g., within a bridge or endpiece of a pair of glasses, etc.).

Resolution refers to how many pixels there are per degree of the viewer's visual field. For color images, the resolution of interest may be related to full-color RGB pixels, such that Resolution expresses how many RGB pixels per degree are presented to the viewer.

FOV refers to the degrees of the field of view that is presented in total. It is desirable for this to be as large as possible so that content can not only be presented in areas directly in front of the user's eyes but also in side areas of the user's peripheral vision and so forth.

Pitch refers to the pixel pitch, or distance between adjacent pixels. As has been mentioned, the effective pitch value of interest for RGB pixels is the distance between any two adjacent pixels of the same color, which may be reduced by employing a plurality of polychrome pixel panels in a coordinated pixel arrangement that allows red, green, and blue light to be superimposed at each pixel position.

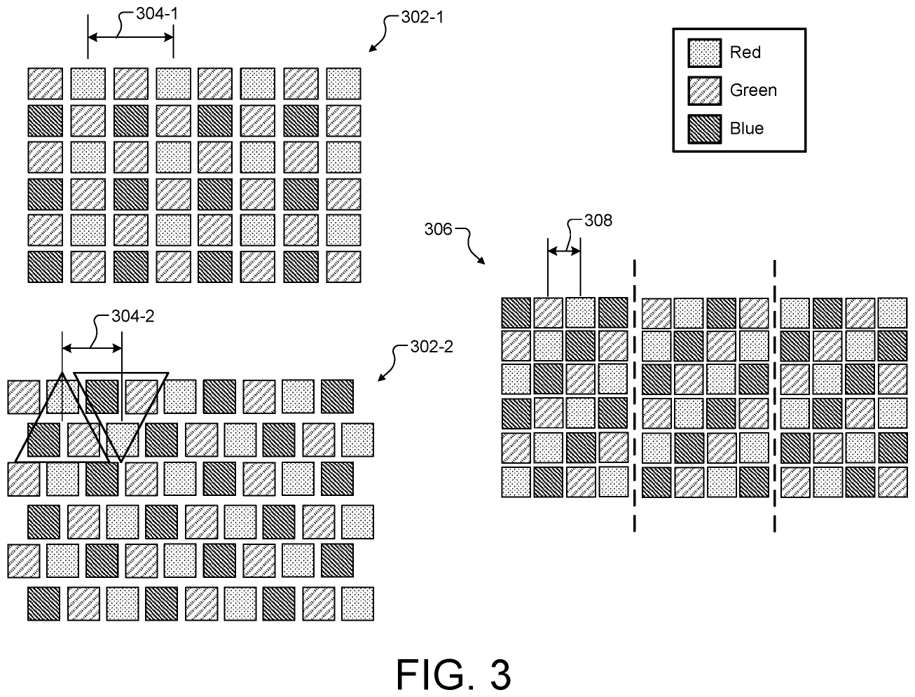

To illustrate, FIG. 3 shows pixel pitch characteristics for illustrative polychrome pixel panels in accordance with principles described herein. Since pixel pitch has a direct relationship with desirable system characteristics (e.g. the relationship represented in Equation 1), it may be desirable for the pixel pitch to be small so as to allow for other desirable characteristics (e.g., the short focal length, the high resolution, the wide field of view, etc.) to be achieved. To this end, FIG. 3 illustrates how using a set of multiple polychrome pixel panels with coordinated pixel arrangements, rather than one conventional polychrome pixel panel, may help reduce the pixel pitch.

FIG. 3 shows portions of two example pixel arrays 302-1 and 302-2 within illustrative polychrome pixel panels that will be understood to represent conventional panels associated with conventional, single-aperture waveguides. Similarly as described above in relation to FIG. 1, individual pixels in pixel arrays 302-1 and 302-2 are depicted as squares with different fill styles representing their color in accordance with the key. The two different pixel arrays 302-1 and 302-2 are each shown to include polychrome pixels in different arrangements. For example, pixel array 302-1 aligns all of the pixels in a grid of rows and columns, while pixel array 302-2 is similarly aligned except that every other row is offset by half a pixel, as shown. In both examples, red, green, and blue pixels are included in equal numbers in a repeating pattern, and a particular pitch equal to the distance between two pixels of the same color (e.g., a red color in this example) is labeled. Specifically, pitch 304-1 for pixel array 302-1 is shown to be as wide as two pixels, while a pitch 304-2 for pixel array 302-2 is shown to be as wide as 1.5 pixels plus additional distance owing to its nearest like-colored neighbor being one row down.

In either case, the respective pitch 304-1 and 304-2 of these respective pixel arrays 302-1 and 302-2 may be significantly greater than the pitch of a pixel array 306 of an illustrative polychrome pixel panel with coordinated pixel arrangements. Because red, green, and blue light may be superimposed onto an effective RGB pixel at every pixel position as described above, pixel array 306 is shown to have a pitch 308 that is only one pixel across (e.g., significantly shorter than either pitch 304-1 or pitch 304-2). For example, if pitch 304-1 is 10 microns (i.e., 0.010 mm) and pitch 304-2 is 10 microns, pitch 308 of each of the pixel arrays 306 of the polychrome pixel panels described herein may be just 5 microns (i.e., 0.005 mm) if these polychrome pixel panels were manufactured using the same process (i.e., so that the pixels are the same size). In other words, all else being equal, the effective pixel pitch of an RGB pixel maybe reduced by around 50% by using multiple polychrome pixel panels with coordinated pixel arrangements in place of conventional polychrome pixel panels. This is a significant pitch decrease that may allow for one or more of: a shorter optical track length, an increased resolution, and/or an increased field of view, as set forth in Equation 1 above. To give a quantitative example, for instance, the focal length for an optical system having a 30 pixel-per-degree (ppd) resolution and 30° field of view would decrease from about 16.8 mm to 8.4 mm by reducing the pixel pitch from 10 microns to 5 microns in this way, thereby making it easier to fit the projection optics into the limited space of a head-mounted display such as a pair of glasses of the like.

As has been described, using multiple polychrome pixel panels with coordinated pixel arrangements (such as illustrated by pixel array 306) rather than single polychrome pixel panels with conventional arrangements (such as illustrated by pixel arrays 302-1 and 302-2) may present a solution to one technical problem (reducing pixel pitch to facilitate high resolution and field of view with an optical track length that fits into a small space) while also presenting a different technical challenge related to color non-uniformity. Specifically, it may be difficult for a multi-aperture waveguide configured for use with separate pixel panels to deliver light from the separate panels to all portions of the user's visible field in a perfectly uniform way. A variety of technical solutions may be applied to mitigate this non-uniformity problem. For example, grating structures and other design parameters within the waveguide may be designed to try to address this issue, adjustments in software to the color data itself may be made to compensate for known non-uniformity characterized for a particular system, and so forth.

These and other approaches may be implemented separately or in combination with one another for a given extended reality projection system design that includes a plurality of pixel panels. However, many of these types of solutions may come with their own costs, such as tending to decrease the brightness of the display that the user secs. For example, if software is used to make one pixel position display a little less red due to known color non-uniformity for that pixel position, the RGB pixel at that pixel position may be a little less bright due to the redness reduction. Accordingly, as has been described and illustrated, pixels within each of the multiple polychrome pixel panels of pixel array 306 may interleave pixels of the various colors in any suitable way so as to mitigate these issues (e.g., rather than being implemented, for example, as three monochrome pixel panels). For example, pixels of different colors may be interleaved according to the pattern shown in pixel array 306 or according to other suitable examples illustrated herein.

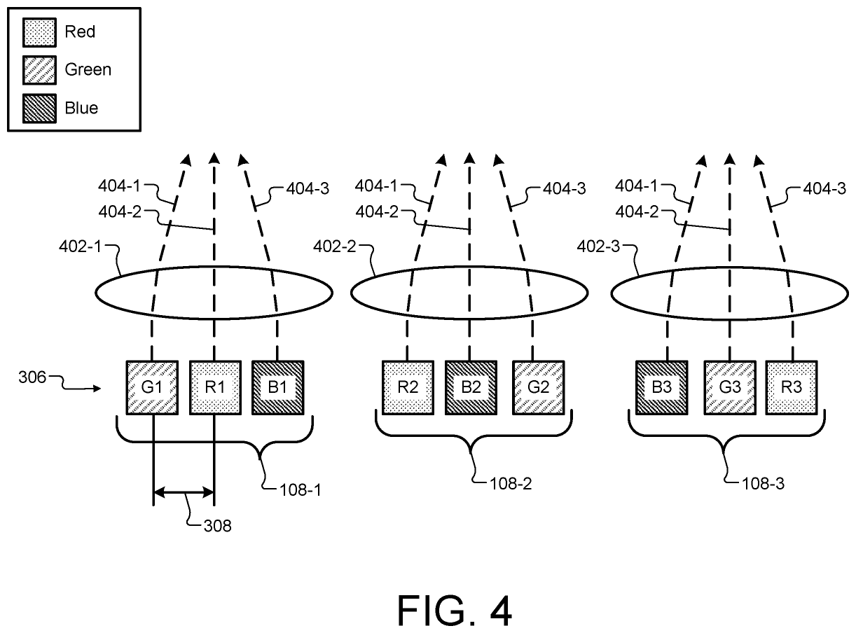

FIG. 4 shows illustrative optical angles presented by corresponding pixels in like pixel positions within coordinated pixel arrangements in accordance with principles described herein. More particularly, various pixels from pixel array 306 are illustrated in FIG. 4 alongside neighboring pixels from the same polychrome pixel panel. Three pixels labeled R1, G1, and B1 from polychrome pixel panel 108-1 are shown to emit light through a first optics channel 402-1; three pixels labeled R2, G2, and B2 from polychrome pixel panel 108-2 are shown to emit light through a second optics channel 402-2; and three pixels labeled R3, G3, and B3 from polychrome pixel panel 108-3 are shown to emit light through a third optics channel 402-3. It will be understood, as has been described and as is explicitly shown for the adjacent G1 and R1 pixels from polychrome pixel panel 108-1, that, within each pixel panel, adjacent pixels may have the pitch 308 described above (i.e., a pixel pitch less than they would have if only a single polychrome pixel panel with a single optics channel were used). It will also be understood that the relative placement of the various pixels in FIG. 4 is indicative of pixel positions of these pixels within their respective polychrome pixel panels. For example, the pixels G1, R2, and B3 (on the left side of each pixel sampling) will all be understood to be located at a same pixel position (e.g., a first pixel position such as pixel position 110-A) within their respective polychrome pixel panels; the pixels R1, B2, and G3 (in the middle of each pixel sampling) will all be understood to be located at another same pixel position (e.g., a second pixel position adjacent to the first pixel position) within their respective polychrome pixel panels; and the pixels B1, G2, and R3 (on the right side of each pixel sampling) will all be understood to be located at yet another same pixel position (e.g., a third pixel position adjacent to the second pixel position) within their respective polychrome pixel panels.

Each optics channel 402-1, 402-2, and 402-3 may represent various optical components that light may travel through between the respective polychrome pixel panels, where the light originates, to the presentation at the user's eye, where the light is consumed. Along this path, certain optical elements may be shared by light emitted from the various pixel panels, while other optical elements may be similar but distinct and independent for each separate polychrome pixel panel. One aspect of the optics channels 402-1, 402-2, and 402-3 that may be separate for the light from each pixel panel is the input aperture into a multi-aperture waveguide. The optical path represented by each optics channel 402-1, 402-2, and 402-3 may include, for example, a different input aperture into a multi-aperture waveguide and a different light channel from the input aperture through the waveguide.

Despite being independent in this way (to support three separate polychrome pixel panels, as has been described), the optics channels 402-1, 402-2, and 402-3 are shown in FIG. 4 to ultimately present light from the different polychrome pixel panels at corresponding angles. For example, the G1 pixel from polychrome pixel panel 108-1, the R2 pixel from polychrome pixel panel 108-2, and the B3 pixel from polychrome pixel panel 108-3 panel are all shown to be presented to the user at a same angle 404-1. As has been described, this superimposing of light from the three differently-colored pixels may effectively form a single RGB pixel that can present white light (or any desired color, based on the brightness of each of the three pixels) at angle 404-1. Similarly, the R1 pixel from polychrome pixel panel 108-1, the B2 pixel from polychrome pixel panel 108-2, and the G3 pixel from polychrome pixel panel 108-3 are all shown to be presented to the user at a same angle 404-2, such that light from these pixels is superimposed to form a second effective RGB pixel at angle 404-2. As a third example, the B1 pixel from polychrome pixel panel 108-1, the G2 pixel from polychrome pixel panel 108-2, and the R3 pixel from polychrome pixel panel 108-3 are all shown to be presented to the user at a same angle 404-3, such that light from these pixels is superimposed to form a third effective RGB pixel at angle 404-3.

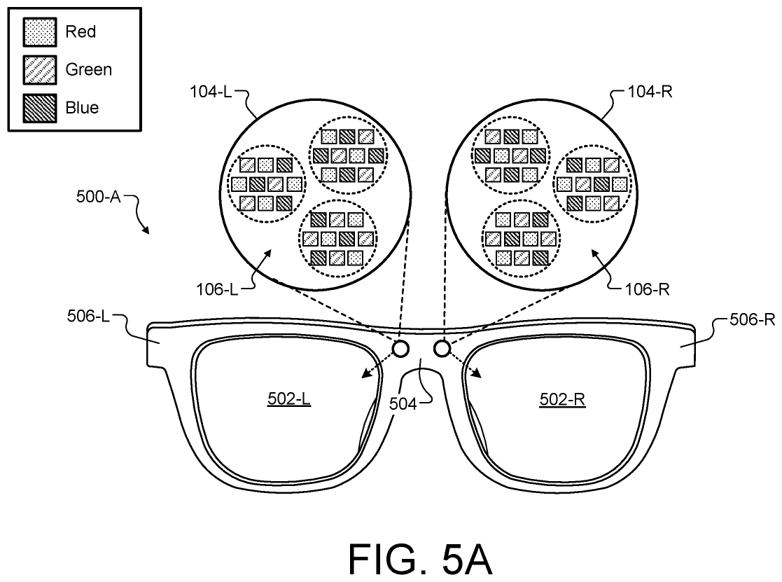

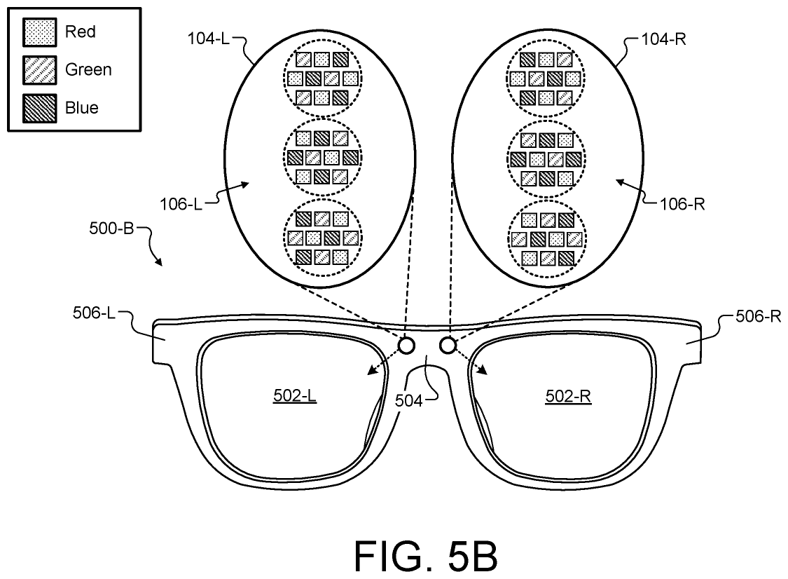

FIGS. 5A through 7 will now be described to further illustrate how extended reality projection may be performed using polychrome pixel panels with coordinated pixel arrangements with a variety of additional useful features. Each of these figures shows an illustrative head-mounted display using polychrome pixel panels with illustrative coordinated pixel arrangements in accordance with principles described herein. The head-mounted display in these examples will be illustrated as augmented reality glasses devices, though it will be understood that the same principles being illustrated could be applied to other types of binocular or monocular head-mounted displays, such as virtual reality headsets, mixed reality headsets, other types of augmented reality headsets, or the like.

FIG. 5A shows a binocular head-mounted display implemented by an augmented reality glasses device 500-A that includes a left lens 502-L and a right lens 502-R each configured to facilitate a display of a color image while allowing a passage of light from an environment. In this and other examples illustrated herein, left and right are labeled and referred to from a perspective in front of the glasses, though it will be understood that a person wearing the glasses would have their left and right reversed from these labels. Augmented reality glasses device 500-A is also shown to include a frame configured to hold left lens 502-L and right lens 502-R. As shown, the glasses frame may have a bridge 504 between a left endpiece 506-L on a left side of augmented reality glasses device 500-A and a right endpiece 506-R on a right side of augmented reality glasses device 500-A. These features of the augmented reality glasses device (i.e., the lenses 502-L and 502-R, the frame having the bridge 504 and the endpieces 506-L and 506-R, etc.) are included not only for the implementation of augmented reality glasses device 500-A but also for the other implementations of the augmented reality glasses device illustrated and described with respect to FIGS. 5B-7.

In the example of FIG. 5A, respective sets of polychrome pixel panels labeled as sets 104-L and 104-R are each shown to be integrated into bridge 504 of the frame. Sets 104-L and 104-R of polychrome pixel panels will be understood to serve as an example implementation of set 104 of polychrome pixel panels illustrated and described above in relation to FIG. 1. In this implementation, a first arrangement 106-L of polychrome pixel panels within set 104-L and a second arrangement 106-R of polychrome pixel panels within set 104-R are shown to serve as example implementations of arrangement 106 described above in relation to FIG. 1. As shown for each of arrangements 106-L and 106-R in the implementation of FIG. 5A, the first panel, the second panel, and the third panel of the respective set 104-L or 104-R of polychrome pixel panels are integrated within the head-mounted display in a triangular arrangement. While particular pixel positions are not explicitly labeled in FIG. 5A as they were in FIG. 1, it will be understood that the respective samplings of pixels depicted in each circle represent pixels from each polychrome pixel panel at corresponding pixel positions. As such, FIG. 5A shows that, for each set 104-L and 104-R, the coordinated pixel arrangements are used to ensure that an effective RGB pixel (capable of producing superimposed red, green, and blue light from corresponding red, green, and blue pixels) is associated with each pixel position, as has been described.

In the example of FIG. 5B, an augmented reality glasses device 500-B also shows sets 104-L and 104-R of polychrome pixel panels being integrated into bridge 504 of the frame. However, in this implementation, both the first arrangement 106-L and the second arrangement 106-R of the polychrome pixel panels are shown to be vertically-stacked arrangements. Differently shaped arrangements such as the triangular arrangements of FIG. 5A and the vertically-stacked arrangements of FIG. 5B may have different implications (e.g., different advantages, tradeoffs, etc.) for certain aspects of the extended reality projection system design, such as for the design of the multiple input apertures and corresponding light channels in the multi-aperture waveguides included in the system. Here again, FIG. 5B illustrates coordinated pixel arrangements for the first, second, and third panels of each set 104-L and 104-R of polychrome pixel panels. These coordinated pixel arrangements can again be seen to form effective RGB pixels capable of producing superimposed red, green, and blue light from corresponding red, green, and blue pixels at each pixel position represented within the samples of corresponding pixels shown in the circles.

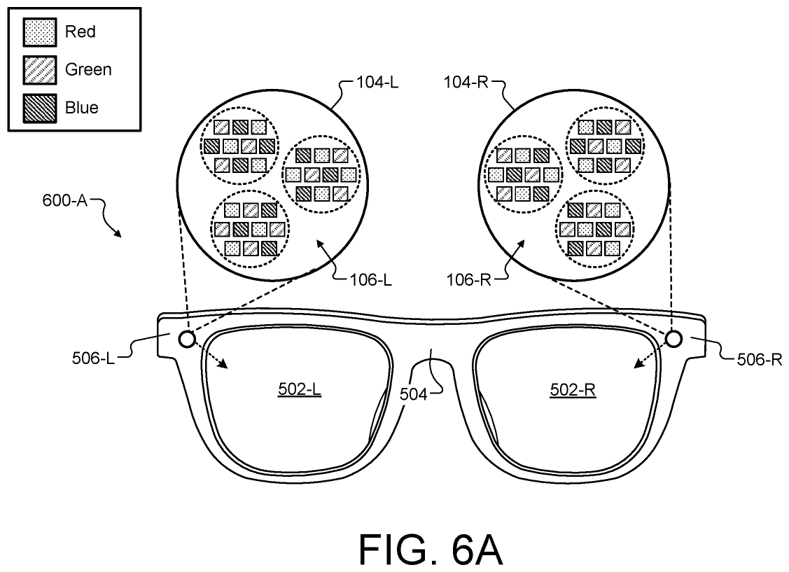

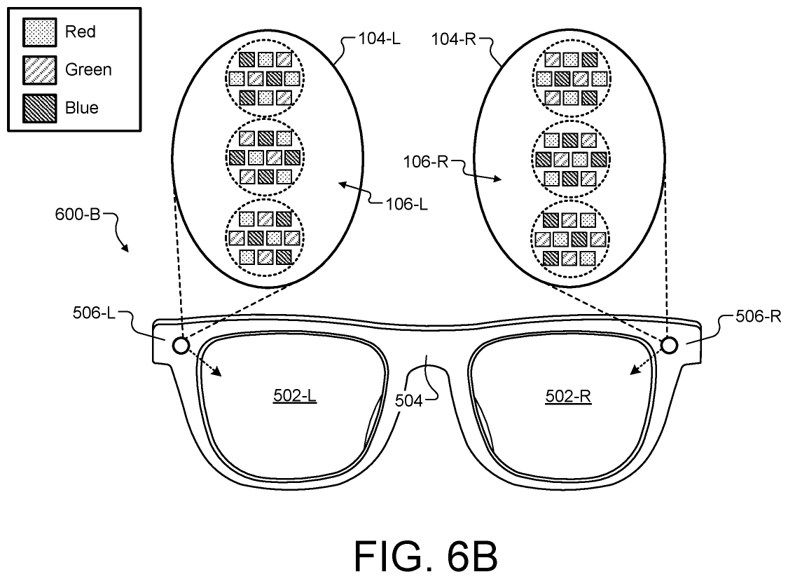

FIGS. 6A and 6B show additional illustrative binocular head-mounted displays using polychrome pixel panels having additional examples of coordinated pixel arrangements in accordance with principles described herein. Specifically, FIG. 6A depicts an example binocular head-mounted display implemented by an augmented reality glasses device 600-A and FIG. 6B depicts an example binocular head-mounted display implemented by an augmented reality glasses device 600-B. As with the glasses devices illustrated and described above in relation to FIGS. 5A and 5B, each of augmented reality glasses devices 600-A and 600-B is shown to include the left lens 502-L and the right lens 502-R each configured to facilitate a display of the color image while allowing a passage of light from an environment. These glasses device implementations also are each shown to include the frame configured to hold left lens 502-L and right lens 502-R, as well as the frame having the bridge 504 between the left endpiece 506-L and the right endpiece 506-R. Whereas the respective sets 104-L and 104-R of polychrome pixel panels were shown to be integrated into bridge 504 in the examples of augmented reality glasses devices 500-A and 500-B, however, FIGS. 6A and 6B show examples in which these sets of polychrome pixel panels are instead integrated into the endpieces of the glasses. Specifically, as shown in both augmented reality glasses devices 600-A and 600-B, set 104-L of polychrome pixel panels is integrated into left endpiece 506-L, while set 104-R of polychrome pixel panels is integrated into right endpiece 506-R.

As with FIGS. 5A and 5B described above, a difference between the implementations of FIGS. 6A and 6B is in the shape of the arrangements 106 of the pixel panels in the respective sets 104-L and 104-R. Specifically, augmented reality glasses device 600-A shows arrangements 106-L and 106-R that are each implemented as triangular arrangements similar to those described above in relation to augmented reality glasses device 500-A. Augmented reality glasses device 600-B then shows arrangements 106-L and 106-R that are each implemented as vertically-stacked arrangements similar to those described above in relation to augmented reality glasses device 500-B. As with the examples of augmented reality glasses devices 500-A and 500-B, the implementations depicted by augmented reality glasses devices 600-A and 600-B both illustrate coordinated pixel arrangements for the first, second, and third panels of each set 104-L and 104-R of polychrome pixel panels. As such, a comparison of the different colored pixels at corresponding pixel positions within any given set reveals that effective RGB pixels are formed at each pixel position to be capable of producing superimposed red, green, and blue light from corresponding red, green, and blue pixels, as has similarly been described above with respect to other examples.

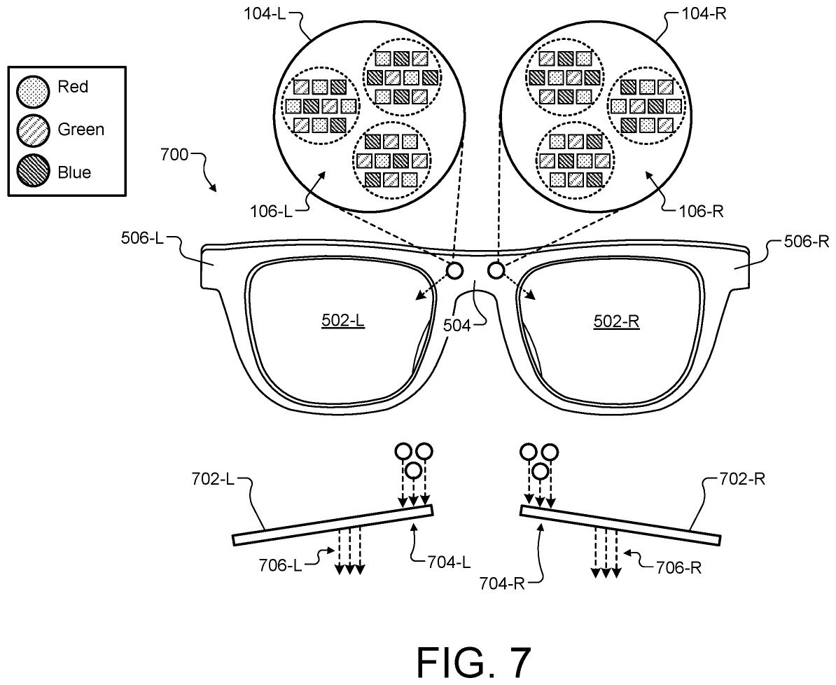

Along with the features explicitly illustrated in the preceding figures, multi-aperture waveguides have been described as being configured to carry or otherwise guide or direct light from a set of discrete polychrome pixel panels to the eyes of a person wearing a head-mounted display. As one example implementation using the glasses form factor, for instance, an augmented reality glasses device may include: 1) a left lens (e.g., left lens 502-L) associated with a left side of the augmented reality glasses device and configured to facilitate a display of a color image while allowing a passage of light from an environment; 2) a right lens (e.g., right lens 502-R) associated with a right side of the augmented reality glasses device and configured to facilitate the display of the color image while allowing the passage of light from the environment; 3) a frame configured to hold the left lens and the right lens and including a left endpiece (e.g., left endpiece 506-L) on the left side, a right endpiece (e.g., right endpiece 506-R) on the right side, and a bridge (e.g., bridge 504) between the left endpiece and the right endpiece; 4) a first set of polychrome pixel panels (e.g., set 104-L) collectively configured to produce the color image for presentation on the left side, the first set of polychrome pixel panels configured with a coordinated pixel arrangement (e.g., arrangement 106-L); 5) a first waveguide configured to guide light from the first set of polychrome pixel panels to achieve the presentation on the left side, the first waveguide integrated into the left lens and including separate input apertures for each polychrome pixel panel in the first set of polychrome pixel panels; 6) a second set of polychrome pixel panels (e.g., set 104-R) collectively configured to produce the color image for presentation on the right side, the second set of polychrome pixel panels configured with the coordinated pixel arrangement (e.g., arrangement 106-R, which, as shown, exhibits the same pixel coordination as arrangement 106-L); and 7) a second waveguide configured to guide light from the second set of polychrome pixel panels to achieve the presentation on the right side, the second waveguide integrated into the right lens and including separate input apertures for each polychrome pixel panel in the second set of polychrome pixel panels. To further illustrate, FIG. 7 shows various aspects of multi-aperture waveguides used by an illustrative binocular head-mounted displays, such as the first and second waveguides mentioned for this example implementation.

In FIG. 7, an example augmented reality glasses device 700 is shown with the same features, including the triangular arrangements of polychrome pixel panels, as illustrated and described above in relation to FIG. 5A. Additionally, as depicted from a bottom view below the glasses device in FIG. 7, augmented reality glasses device 700 is shown to include a first waveguide 702-L that will be understood to be integrated into left lens 502-L and a second waveguide 702-R that will be understood to be integrated into right lens 502-R. The waveguide 702-L may be configured to guide light from set 104-L of the polychrome pixel panels to achieve the presentation on the left side of the glasses device. To this end, as illustrated by individual arrows extending to waveguide 702-L from small circles representing the polychrome pixel panels of set 104-L, waveguide 702-L is shown to include a set 704-L of separate input apertures for each polychrome pixel panel in set 104-L of polychrome pixel panels. As light is input at this set 704-L of separate input apertures, waveguide 702-L may be configured to guide the light from the pixels of the different polychrome pixel panels to be output at proper angles to an eye of the user as light 706-L.

Similarly, waveguide 702-R may be configured to guide light from set 104-R of the polychrome pixel panels to achieve the presentation on the right side of the glasses device. To this end, as illustrated by individual arrows extending to waveguide 702-R from small circles representing the polychrome pixel panels of set 104-R, the waveguide 702-R is shown to include a set 704-R of separate input apertures for each polychrome pixel panel in set 104-R of polychrome pixel panels. As light is input at this set 704-R of separate input apertures, waveguide 702-R may be configured to guide the light from the pixels of the different polychrome pixel panels to be output at proper angles to the other eye of the user as light 706-R. Due to the coordinated pixel arrangements 106-L and 106-R of the polychrome pixel panels, each of the eyes of the user may see color non-uniformities that complement and are perceived as cancelling one another out, as has been described.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementations in one or more computer programs that are executable and/or interpretable on a programmable system including at least one programmable processor, which may be special or general purpose, coupled to receive data and instructions from, and to transmit data and instructions to, a storage system, at least one input device, and at least one output device.

A number of implementations have been described. Nevertheless, it will be understood that various modifications may be made without departing from the spirit and scope of the description and claims. In addition, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

Specific structural and functional details disclosed herein are merely representative for purposes of describing example implementations. Example implementations, however, may be embodied in many alternate forms and should not be construed as limited to only the implementations set forth herein.

The terminology used herein is for the purpose of describing particular implementations only and is not intended to be limiting of the implementations. As used herein, the singular forms “a,” “an,” and “the” are intended to include the plural forms as well, unless the context clearly indicates otherwise. It will be further understood that the terms “comprises,” “comprising,” “includes,” and/or “including,” when used in this specification, specify the presence of the stated features, steps, operations, elements, and/or components, but do not preclude the presence or addition of one or more other features, steps, operations, elements, components, and/or groups thereof.

It will be understood that when an element is referred to as being “coupled,” “connected,” or “responsive” to, or “on,” another element, it can be directly coupled, connected, or responsive to, or on, the other element, or intervening elements may also be present. In contrast, when an element is referred to as being “directly coupled,” “directly connected,” or “directly responsive” to, or “directly on,” another element, there are no intervening elements present. As used herein, the term “and/or” includes any and all combinations of one or more of the associated listed items.

Spatially relative terms, such as “beneath,” “below,” “lower,” “above,” “upper,” and the like, may be used herein for ease of description to describe one element or feature in relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device may be otherwise oriented (rotated 130 degrees or at other orientations) and the spatially relative descriptors used herein may be interpreted accordingly.

It will be understood that although the terms “first,” “second,” etc. may be used herein to describe various elements, these elements should not be limited by these terms. These terms are only used to distinguish one element from another. Thus, a “first” element could be termed a “second” element without departing from the teachings of the present implementations.

Unless otherwise defined, the terms (including technical and scientific terms) used herein have the same meaning as commonly understood by one of ordinary skill in the art to which these concepts belong. It will be further understood that terms, such as those defined in commonly used dictionaries, should be interpreted as having a meaning that is consistent with their meaning in the context of the relevant art and/or the present specification and will not be interpreted in an idealized or overly formal sense unless expressly so defined herein.

While certain features of the described implementations have been illustrated as described herein, many modifications, substitutions, changes, and equivalents may occur to those skilled in the art. It is therefore to be understood that the appended claims are intended to cover such modifications and changes as fall within the scope of the implementations. It will be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components, and/or features of the different implementations described. As such, the scope of the present disclosure is not limited to the particular combinations hereafter claimed, but instead extends to encompass any combination of features or example implementations described herein irrespective of whether or not that particular combination has been specifically enumerated in the accompanying claims at this time.

What is claimed is:

1. An extended reality projection system comprising:
a head-mounted display; and
a set of polychrome pixel panels collectively configured to produce a color image for presentation on the head-mounted display, the set of polychrome pixel panels configured with a coordinated pixel arrangement in which, for a particular pixel position:
a first panel of the set of polychrome pixel panels includes a red pixel,
a second panel of the set of polychrome pixel panels includes a green pixel, and
a third panel of the set of polychrome pixel panels includes a blue pixel.

2. The extended reality projection system of claim 1, wherein the head-mounted display is implemented by an augmented reality glasses device that includes:
a lens configured to facilitate a display of the color image while allowing a passage of light from an environment; and
a frame configured to hold the lens and including:
a left endpiece on a left side of the augmented reality glasses device,
a right endpiece on a right side of the augmented reality glasses device, and
a bridge between the left endpiece and the right endpiece.

3. The extended reality projection system of claim 2, wherein the set of polychrome pixel panels is integrated into the bridge of the frame.

4. The extended reality projection system of claim 2, wherein the set of polychrome pixel panels is integrated into one of the left endpiece of the frame or the right endpiece of the frame.

5. The extended reality projection system of claim 2, wherein:
the lens is a left lens and the augmented reality glasses device further includes a right lens configured to facilitate a display of the color image while allowing the passage of light from the environment;
the frame is configured to hold the left lens on the left side and to hold the right lens on the right side;
the set of polychrome pixel panels is a first set of polychrome pixel panels collectively configured to produce the color image for presentation on the left side; and
the extended reality projection system further includes a second set of polychrome pixel panels collectively configured to produce the color image for presentation on the right side, the second set of polychrome pixel panels configured with the coordinated pixel arrangement.

6. The extended reality projection system of claim 1, further comprising a waveguide configured to guide light from the set of polychrome pixel panels to achieve the presentation on the head-mounted display, the waveguide including separate input apertures for each of the first panel, the second panel, and the third panel of the set of polychrome pixel panels.

7. The extended reality projection system of claim 6, wherein the head-mounted display is implemented by an augmented reality glasses device that includes a lens into which the waveguide is integrated, the lens configured to facilitate a display of the color image while allowing a passage of light from an environment.

8. The extended reality projection system of claim 1, wherein the first panel, the second panel, and the third panel of the set of polychrome pixel panels are integrated within the head-mounted display in a triangular arrangement.

9. The extended reality projection system of claim 1, wherein the first panel, the second panel, and the third panel of the set of polychrome pixel panels are integrated within the head-mounted display in a vertically-stacked arrangement.

10. A method comprising:
producing, by a red pixel at a particular pixel position in a first panel of a set of polychrome pixel panels within a head-mounted display, red light for a color image presented on the head-mounted display;
producing, by a green pixel at the particular pixel position in a second panel of the set of polychrome pixel panels, green light for the color image; and
producing, by a blue pixel at the particular pixel position in a third panel of the set of polychrome pixel panels, blue light for the color image.

11. The method of claim 10, wherein the head-mounted display is implemented by an augmented reality glasses device that includes:
a lens configured to facilitate a display of the color image while allowing a passage of light from an environment; and
a frame configured to hold the lens and including:
a left endpiece on a left side of the augmented reality glasses device,
a right endpiece on a right side of the augmented reality glasses device, and
a bridge between the left endpiece and the right endpiece.

12. The method of claim 10, further comprising:
receiving, by way of a first input aperture of a waveguide configured to guide light from the set of polychrome pixel panels to present the color image on the head-mounted display, the red light;
receiving, by way of a second input aperture of the waveguide, the green light; and
receiving, by way of a third input aperture of the waveguide, the blue light.

13. The method of claim 12, wherein the head-mounted display is implemented by an augmented reality glasses device that includes a lens into which the waveguide is integrated, the lens configured to allow a passage of light from an environment while facilitating a display of the color image.

14. An augmented reality glasses device comprising:
a left lens associated with a left side of the augmented reality glasses device and configured to facilitate a display of a color image while allowing a passage of light from an environment;
a right lens associated with a right side of the augmented reality glasses device and configured to facilitate the display of the color image while allowing the passage of light from the environment;
a frame configured to hold the left lens and the right lens and including a left endpiece on the left side, a right endpiece on the right side, and a bridge between the left endpiece and the right endpiece;
a first set of polychrome pixel panels collectively configured to produce the color image for presentation on the left side, the first set of polychrome pixel panels configured with a coordinated pixel arrangement;
a first waveguide configured to guide light from the first set of polychrome pixel panels to achieve the presentation on the left side, the first waveguide integrated into the left lens and including separate input apertures for each polychrome pixel panel in the first set of polychrome pixel panels;
a second set of polychrome pixel panels collectively configured to produce the color image for presentation on the right side, the second set of polychrome pixel panels configured with the coordinated pixel arrangement; and
a second waveguide configured to guide light from the second set of polychrome pixel panels to achieve the presentation on the right side, the second waveguide integrated into the right lens and including separate input apertures for each polychrome pixel panel in the second set of polychrome pixel panels.

15. The augmented reality glasses device of claim 14, wherein both the first set of polychrome pixel panels and the second set of polychrome pixel panels are integrated into the bridge of the frame.

16. The augmented reality glasses device of claim 14, wherein:
the first set of polychrome pixel panels is integrated into the left endpiece of the frame; and
the second set of polychrome pixel panels is integrated into the right endpiece of the frame.

17. The augmented reality glasses device of claim 14, wherein:
the first set of polychrome pixel panels is integrated within the frame in a first triangular arrangement; and
the second set of polychrome pixel panels is integrated within the frame in a second triangular arrangement.

18. The augmented reality glasses device of claim 14, wherein:
the first set of polychrome pixel panels is integrated within the frame in a first vertically-stacked arrangement; and
the second set of polychrome pixel panels is integrated within the frame in a second vertically-stacked arrangement.
